(19) United States
(12) Patent Application Publication
(10) Pub. No.: US 2007/0046134 A1
(43) Pub. Date: Mar. 1, 2007

(54) Commutator and method for manufacturing commutator

(76) Inventors: Yoshiki Nakano, Hamamatsu-shi (JP); Yoshitaka Tao, Toyohashi-shi (JP); Ryohei Kageyama, Hamamatsu-shi (JP)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/507,996

(22) Filed: Aug. 22, 2006

(30) Foreign Application Priority Data
Aug. 24, 2005 (JP) 2005-243203

(51) Int. Cl. H01R 39/32; H01R 43/10

(52) U.S. Cl. 310/234; 29/597

(57) ABSTRACT

A commutator includes a commutator body having segments and a short circuit member for short-circuiting the segments. The short circuit member includes first short circuit pieces and second short circuit pieces that are stacked. A radially outer end portion of each first short circuit piece is overlapped with and connected to a radially outer end portion of one of the second short circuit pieces. The short circuit member is arranged at an axial end of the commutator body such that each pair of the overlapped radially outer end portions corresponds to one of the segments. The radially outer end portions and the segments each have a connecting projection. The connecting projections of each pair of the overlapped radially outer end portions and the connecting projection of the corresponding segment are arranged to form an adjacently arranged set of the connecting projections, which are bonded by welding.

### BACKGROUND OF THE INVENTION

The present invention relates to a commutator formed by joining a commutator body with a plurality of segments arranged around the outer circumference of the commutator body with a plate-like short circuit member that equalizes potentials of prescribed ones of the segments by short-circuiting the segments and a method for manufacturing the commutator.

In a typical motor including a commutator such as a DC motor, the minimum common multiplier of the number of the magnetic poles of a stator and the number of teeth of an armature core (the number of coils wound around the teeth) are the same as the number of segments of the commutator. In this commutator, the potentials of prescribed ones of the segments must be equalized by short-circuiting the segments. Thus, for example, Japanese Laid-Open Patent Publication No. 2005-137193 has proposed a commutator with a plate-like short circuit member that is provided integrally with the commutator.

Specifically, the short circuit member has first short circuit pieces and second short circuit pieces that are overlapped with one another. The number of the first short circuit pieces and the number of the second short circuit pieces are the same as the number of segments. The radially inner end portion of each first short circuit piece is overlapped with and electrically connected to the radially inner end portion of one of the second short circuit pieces. The radially outer end portion of each first short circuit piece is overlapped with and electrically connected to the radially outer end portion of one of the second short circuit pieces. In this manner, the short circuit member forms a substantially disk-like double-layered shape. The short circuit member is arranged at an axial end of the commutator body. The radially outer end portions of the first and second short circuit pieces are connected to the corresponding segments arranged around the outer circumference of the commutator body. In this manner, the potentials of prescribed ones of the segments are equalized by short-circuiting the segments through the short circuit member.

To connect the radially outer end portions of the first and second short circuit pieces and the segments together, the radially outer end portions and the segments are bonded together through welding. Such bonding may cause an increased resistance in each of the connecting portions of the radially outer end portions of the first and second short circuit pieces and the segments. This may greatly influence the properties of the motor depending on the configuration of the motor. It is thus necessary to provide a highly reliable bonding method that minimizes increase of the resistance of each connecting portion caused by bonding. On the other hand, the bonding process of such an improved method is desired to be simple.

However, the technique of Japanese Laid-Open Patent Publication No. 2005-137193 does not satisfy the above-described necessity regarding improved bonding. It is thus desired that bonding of the connecting portions be achieved easily and reliably.

### SUMMARY OF THE INVENTION

Accordingly, it is an objective of the present invention to provide a commutator in which a short circuit member and segments are bonded together easily and reliably, and a method for manufacturing the commutator.

To achieve the foregoing objectives and in accordance with one aspect of the present invention, a method of manufacturing a commutator is provided. The commutator includes a commutator body having a plurality of segments arranged along a circumferential direction, and a short circuit member for short-circuiting the segments. The short circuit member is substantially shaped like a disk and has first short circuit pieces and second short circuit pieces that are stacked together to form a two-layer structure. The number of the first short circuit pieces and the number of the second short circuit pieces are each equal to the number of the segments. A radially inner end portion of each first short circuit piece is overlapped with and connected to a radially inner end portion of one of the second short circuit pieces, and a radially outer end portion of each first short circuit piece is overlapped with and connected to a radially outer end portion of one of the second short circuit pieces, such that a plurality of pairs of overlapped end portions arranged at a predetermined angular interval are electrically connected to one another. The method includes: arranging the short circuit member at an axial end of the commutator body such that each pair of the overlapped radially outer end portions corresponds to one of the segments, wherein the radially outer end portions and the segments each have a connecting projection; arranging the connecting projections of each pair of the overlapped radially outer end portions and the connecting projection of the corresponding segment to form an adjacently arranged set of the connecting projections when the short circuit member is arranged at the axial end of the commutator body; and welding the distal ends of each adjacently arranged set of the connecting projections, thereby bonding the distal ends together.

In accordance with another aspect of the present invention, a commutator that includes a commutator body having a plurality of segments arranged along a circumferential direction, and a short circuit member for short-circuiting the segments is provided. The short circuit member is substantially shaped like a disk and has first short circuit pieces and second short circuit pieces that are stacked together to form a two-layer structure. The number of the first short circuit pieces and the number of the second short circuit pieces are each equal to the number of the segments. A radially inner end portion of each first short circuit piece is overlapped with and connected to a radially inner end portion of one of the second short circuit pieces, and a radially outer end portion of each first short circuit piece is overlapped with and connected to a radially outer end portion of one of the second short circuit pieces, such that a plurality of pairs of overlapped end portions arranged at a predetermined angular interval are electrically connected to one another. The short circuit member is arranged at an axial end of the commutator body such that each pair of the overlapped radially outer end portions corresponds to one of the segments. The radially outer end portions and the segments each have a connecting projection. The connecting projections of each pair of the overlapped radially outer end portions and the connecting projection of the corresponding segment are arranged to form an adjacently arranged set of the connecting projections in a state where the short circuit member is arranged at the axial end of the commutator body. The distal ends of each adjacently arranged set of the connecting projections are bonded by welding.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view showing a motor according to one embodiment of the present invention, taken along a direction perpendicular to the axis of the motor;

FIG. 2 is a cross-sectional view showing the motor taken along the axial direction of the motor;

FIG. 3 is a plan view showing a short circuit member;

FIG. 4A is a development diagram representing the electric configuration of the motor;

FIG. 4B is a circuit diagram representing the wiring state of coils;

FIG. 5 is a perspective view showing a commutator as viewed from the bottom of the commutator;

FIG. 5A is an enlarged view showing a section indicated by circle 5A in FIG. 5;

FIG. 6 is a perspective view showing a commutator of a modification as viewed from the bottom of the commutator;

FIG. 6A is an enlarged view showing a section indicated by circle 6A in FIG. 6;

FIG. 7 is a perspective view showing a commutator of another modification as viewed from the bottom of the commutator;

FIG. 7A is an enlarged view showing a section indicated by circle 7A in FIG. 7;

FIG. 8 is a perspective view showing a commutator of another modification as viewed from the bottom of the commutator; and

FIG. 8A is an enlarged view showing a section indicated by circle 8A in FIG. 8.

### DETAILED DESCRIPTION OF THE PREFERRED EMBODIMENTS

An embodiment of the present invention will now be described with reference to the attached drawings.

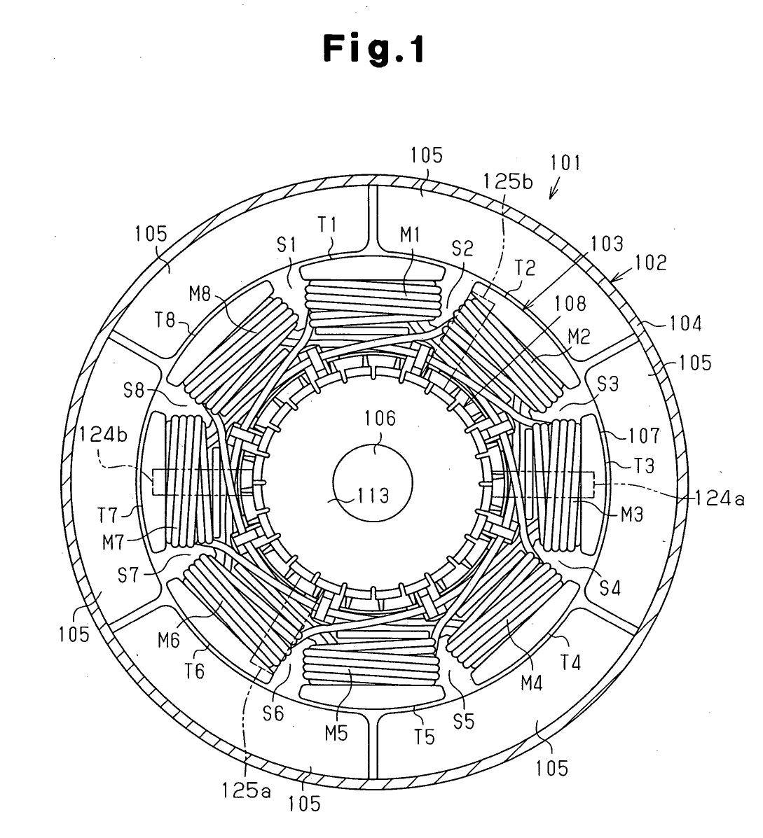

As shown in FIG. 1, a DC motor 101 of the illustrated embodiment includes a stator 102 and an armature 103 that rotates relative to the stator 102. The stator 102 has a yoke housing 104 shaped like a cylinder with a closed bottom and six magnets 105, which are secured to an inner peripheral surface of the yoke housing 104 and spaced at equal angular intervals. Since the stator 102 includes the six magnets 105, six field magnetic poles are provided in the stator 102.

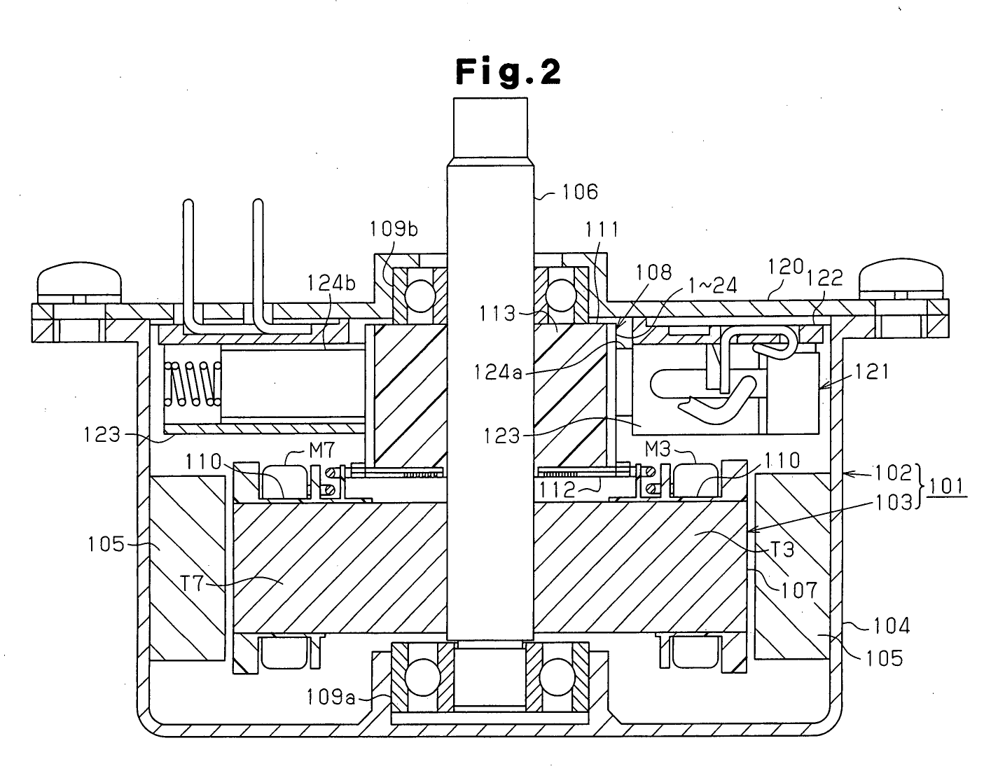

As shown in FIGS. 1 and 2, the armature 103 includes a rotary shaft 106, an armature core 107, and a commutator 108. The armature core 107 and the commutator 108 are fixed to the rotary shaft 106. Referring to FIG. 2, the basal end of the rotary shaft 106 of the armature 103 is rotatably supported by a bearing 109a. The bearing 109a is arranged at the center of the bottom of the yoke housing 104. A prescribed distal portion of the rotary shaft 106 is rotatably supported by a bearing 109b arranged at the center of an end housing 120. The end housing 120 closes the opening of the yoke housing 104. The distal end of the rotary shaft 106 projects from the end housing 120. The armature core 107 of the armature 103 radially opposes the magnets 105 in a state supported by the bearings 109a, 109b.

The armature core 107 includes eight teeth T1 to T8, which extend in radial directions about the rotary shaft 106. Slots S1 to S8 are each defined between an adjacent pair of the teeth T1 to T8. A conductive wire is wound around each of the teeth T1 to T8 through an insulator 110 in a concentrated manner, thus forming coils M1 to M8. The eight coils M1 to M8 provide eight salient magnetic poles in the armature 103.

With reference to FIG. 2, the commutator 108 includes a commutator body 111 and a short circuit member 112. The commutator body 111 has a substantially cylindrical body insulating member 113 and twenty-four segments 1 to 24. The segments 1 to 24 are arranged circumferentially along the outer peripheral surface of the body insulating member 113. The short circuit member has a substantially disk-like shape and is fixed to an end surface of the commutator body 111 corresponding to the armature core 107. In this state, the extending direction of the short circuit member 112 is perpendicular to the axial direction of the commutator body 111.

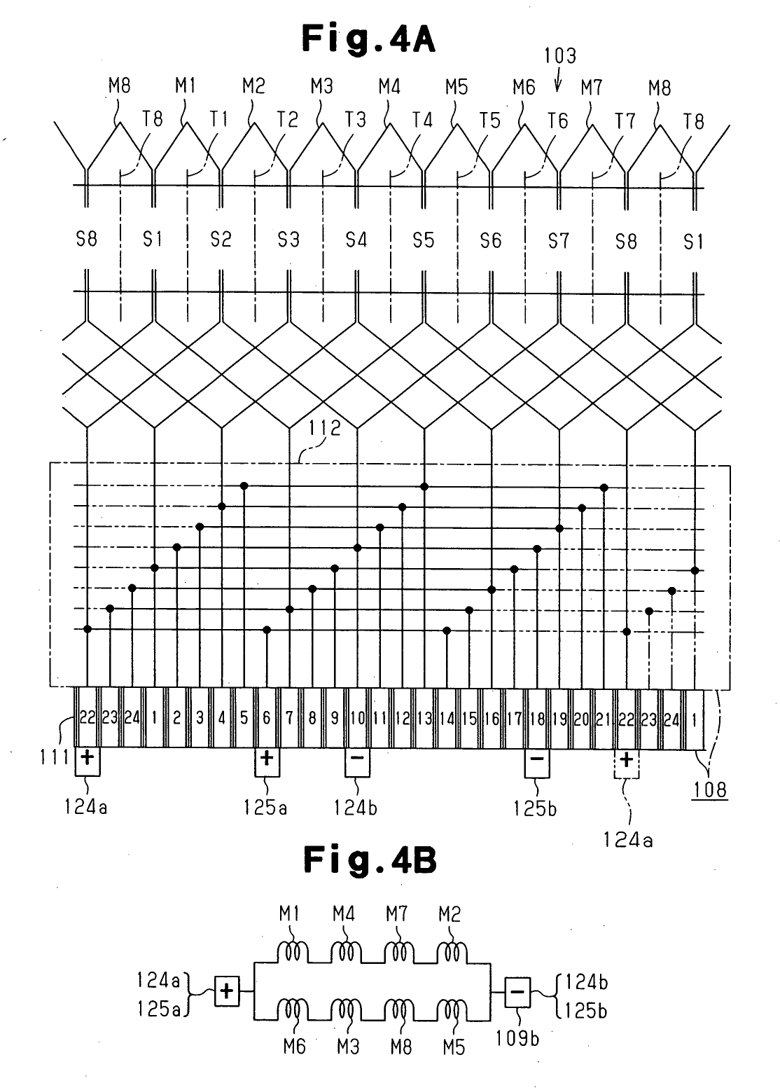

As illustrated in FIG. 4A, the short circuit member 112 electrically connects corresponding ones of the twenty-four segments 1 to 24 that are spaced at intervals of 120 degrees. In other words, the short circuit member 112 short-circuits the segments that are arranged at the intervals of 120 degrees, which are, for example, the segments 5, 13, 21 or the segments 1, 9, 17. The potentials of the segments in each short-circuited set become equal.

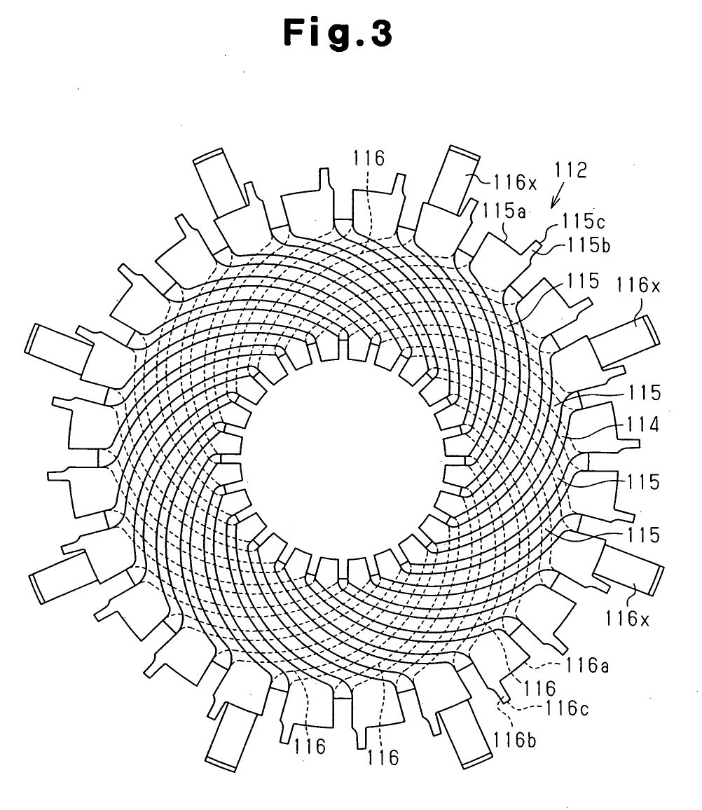

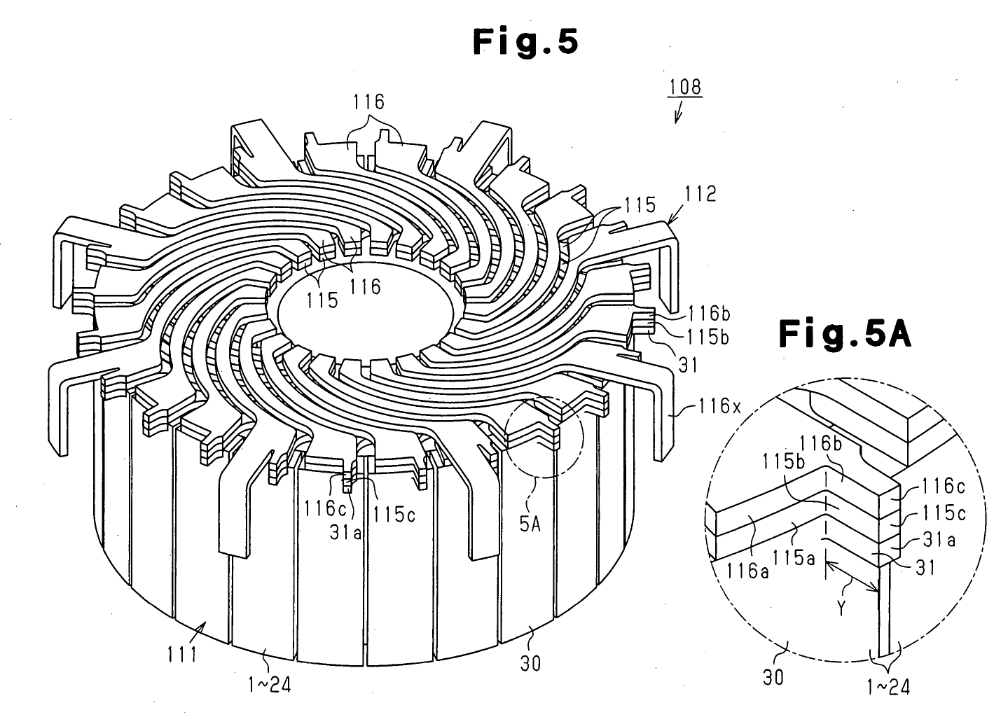

As shown in FIG. 3, the short circuit member 112 has two layers that are arranged at opposing sides of an insulating sheet 114. The short circuit member 112 includes twenty-four first short circuit pieces 115 arranged in one of the layers and the same number of second short circuit pieces 116 provided in the other layer (In FIG. 5, which will be explained later, the insulating sheet 114 is not illustrated). In the illustrated embodiment, the first and second short circuit pieces 115, 116 are formed through pressing of plate members of the same metal as that of the segments 1 to 24.

The first short circuit pieces 115, which are located closer to the viewer of FIG. 3 than the insulating sheet 114, are formed in such a manner that an radially inner end portion of each of the first short circuit pieces 115 is arranged circumferentially offset at 60 degrees from an radially outer end portion of the first short circuit piece 115. The first short circuit pieces 115 are arranged at predetermined circumferential intervals on one plane. The second short circuit pieces 116 (indicated by the broken lines of FIG. 3), which are located farther from the viewer of the drawing than the insulating sheet 114, are formed in such a manner that an radially inner end portion of each of the second short circuit pieces 116 is arranged circumferentially offset at 60 degrees from an radially outer end portion of the second short circuit piece 116 (in directions opposed to the directions of the cases of the first short circuit pieces 115). The second short circuit pieces 116 are arranged at predetermined circumferential intervals on one plane.

The radially outer end portion of each first short circuit piece 115 is overlapped and bonded with the radially outer end portion of the corresponding second short circuit piece 116. The radially inner end portion of each first short circuit piece 115 is overlapped and bonded with the radially inner end portion of the corresponding second short circuit piece 116. The corresponding ones of the short circuit pieces 115, 116 that are spaced at intervals of 120 degrees are electrically connected together. With reference to FIGS. 5 and 5A, the short circuit member 112 is provided in such a manner that the commutator body 111 is located at the side corresponding to the first short circuit pieces 115. The radially outer end portions of the short circuit member 112 are bonded with the segments 1 to 24. The short circuit member 112 short-circuits the corresponding ones of the segments 1 to 24 that are spaced at the intervals of 120 degrees. This equalizes the potentials of the segments in each short-circuited set of the commutator 108.

Bonding of the segments 1 to 24 of the commutator body 111 with the first and second short circuit pieces 115, 116 of the short circuit member 112 will hereafter be explained in detail with reference to FIGS. 3, 5 and 5A.

Each of the first short circuit pieces 115 includes a connecting projection 115b projecting from the radially outer end portion, or an outer peripheral portion 115a, which is flush with an outer peripheral surface (a brush sliding surface) 30 of the corresponding segment 1 to 24, in a radial outward direction (in the direction in which the first short circuit piece 115 extends). Similarly, each of the second short circuit pieces 116 includes a connecting projection 116b projecting from the radially outer end portion, or an outer peripheral portion 116a, which is flush with the outer peripheral surface 30 of the corresponding segment 1 to 24, in a radial outward direction (in the direction in which the second short circuit piece 116 extends). Each of the connecting projections 115b, 116b is located at a circumferentially offset position with respect to the corresponding outer peripheral portion 115a, 116a. The axial dimension of each connecting projection 115b, 116b is equal to the thickness of each of the first and second short circuit pieces 115, 116. The circumferential dimension of the connecting projection 115b, 116b is also equal to the thickness of the first or second short circuit pieces 115, 116. The connecting projection 115b, 116b thus has a parallelepiped shape having a square cross-sectional shape.

Each of the segments 1 to 24 includes a connecting projection 31, which projects radially outward from an axial end (at the side corresponding to the first short circuit piece 115) of the outer peripheral surface 30 of the segment 1 to 24. Each of the connecting projections 31 has a shape identical with (a volume identical to) that of the connecting projection 115b, 116b of each of the short circuit pieces 115, 116. The connecting projections 115b, 116b of each pair of the first and second short circuit pieces 115, 116 and the connecting projection 31 of the corresponding one of the segments 1 to 24 are overlapped with one another in the axial direction while each opposing pair of the sides of the connecting projections 115b, 116b, 31 are held in contact with each other. This prevents the connecting projections 115b, 116b from crossing one another.

In the illustrated embodiment, the connecting projections 31, 115b, 116b project from the same circumferential surface (the outer peripheral surfaces 30 of the segments 1 to 24) in similar manners. Thus, distal end surfaces (radially outer end portion surfaces) 31a, 115c, 116c of the connecting projections 31, 115b, 116b are flush with one another. The distal portions of the connecting projections 31, 115b, 116b are bonded together by, in the illustrated embodiment, a Tig welding machine or a laser welding machine. The machining end (not shown) of the welding machine is pointed at the distal end surfaces 31a, 115c, 116c of the connecting projections 31, 115b, 116b from, for example, radially outward.

As has been described, in the illustrated embodiment, the distal end surfaces 31a, 115c, 116c of the connecting projections 31, 115b, 116b are flush with one another. This equalizes the heat energies of the welding machine received by the connecting projections 31, 115b, 116b. The bonding of the distal portions of the connecting projections 31, 115b, 116b thus becomes easy and reliable. Further, the connecting projections 31, 115b, 116b are formed of the same metal material and have the identical shapes (the equal volumes). The thermal capacities of the connecting projections 31, 115b, 116b are thus equal. Therefore, the distal portions of the connecting projections 31, 115b, 116b melt in similar manners while being bonded together, which also ensures reliable bonding of the connecting projections 31, 115b, 116b.

Risers 116x extend from the outer peripheral portions 116a of the corresponding ones of the second short circuit pieces 115 that are located at intervals of 45 degrees. The ends of the coils M1 to M8 are connected to and secured by the risers 116x. Each of the risers 116x is provided in a portion of the outer peripheral portion 116a of the corresponding second short circuit piece 116 other than the portion corresponding to the connecting projection 116b. The end of each coil M1 to M8 is engaged with and electrically connected to the corresponding riser 116x. In this manner, while being wound around the corresponding segments 1 to 24, the coils M1 to M8 form a common closed loop as illustrated in FIG. 4B.

Referring to FIG. 2, a brush holder device 121 is secured to an inner wall surface of the end housing 120, which closes the opening of the yoke housing 104. The brush holder device 121 includes an annular holder base 122, a brush holder 123, and two pairs of (a total of four) feeder brushes 124a, 124b, 125a, 125b, which are shown in FIG. 1. The holder base 122 is secured to the end housing 120, while the brush holder 123 projects from the holder base 122. The feeder brushes 124a, 124b, 125a, 125b are supported by the brush holder 123.

The feeder brushes 124a, 124b, which form a pair, are spaced at an interval of 180 degrees. The feeder brushes 125a, 125b, which form another pair, are also spaced at an interval of 180 degrees. The feeder brushes 124a, 125a correspond to anodes and the feeder brushes 124b, 125b correspond to cathodes. The feeder brushes 124a, 125a have equal potentials and the feeder brushes 124b, 125b have equal potentials. The feeder brush 124a and the feeder brush 124b are spaced from the feeder brush 125a and the feeder brush 125b, respectively, at intervals of 120 degrees. This causes the feeder brushes 124a, 125a and the feeder brushes 124b, 125b to simultaneously contact the corresponding ones of the segments 1 to 24 that are spaced at the intervals of 120 degrees, the potentials of which are equalized by the short circuit member 112.

Powered by an external source while held in contact (slidable contact) with the commutator 108 (the corresponding segments 1 to 24), the feeder brushes 124a, 124b, 125a, 125b feed power to the armature 103 (the coils M1 to M8) through the commutator 108. This drives the motor 101 to rotate.

The illustrated embodiment has the following advantages.

(1) In the short circuit member 112, the connecting projection 115b, 116b, 31 projects from the radially outer end portion of each of the first and second short circuit pieces 115, 116 and the segments 1 to 24, which are provided along the outer circumference of the commutator body 111. The distal end surfaces 115c, 116c, 31a of the corresponding connecting projections 115b, 116b, 31 are arranged adjacently and flush with one another. The distal end surfaces 31a, 115c, 116c of each connecting projections 31, 115b, 116b are subjected to welding such as Tig welding or laser welding. The distal ends of the corresponding connecting projections 31, 115b, 116b are thus bonded together. Since the distal end surfaces 31a, 115c, 116c of the connecting projections 31, 115b, 116b are flush with one another, equal heat energy is received by each of the distal end surfaces 31a, 115c, 116c from the machining end of the welding machine. Bonding of the distal end surfaces 31a, 115c, 116c is thus accomplished easily and reliably. Being small components, the connecting projections 31, 115b, 116b each have a small thermal capacity. The distal portion of each of the connecting projections 31, 115b, 116b of such a small thermal capacity readily receives heat energy during welding. The connecting projections 31, 115b, 116b are thus easily melt and firmly bonded together. This enhances the reliability of the commutator 108 manufactured by the method of the illustrated embodiment and reduces the manufacturing cost.

(2) The first and second short circuit pieces 115, 116 and the segments 1 to 24 are formed of the same metal material. Further, in the first and second short circuit pieces 115, 116 and the segments 1 to 24, at least a section of each of the connecting projections 115b, 116b, 31 including the distal end surface 115c, 116c, 31a (in the illustrated embodiment, the entire connecting projections 115b, 116b, 31 indicated by range Y of FIG. 5A, since the projections 115b, 116b, 31 project from the common circumferential surface) have identical shapes and equal volumes. This equalizes the thermal capacities of at least the sections of the connecting projections 31, 115b, 116b that include the distal end surfaces 31a, 115c, 116c. The heat energies of the welding machine received by the connecting projections 31, 115b, 116b thus become equal, further increasing the reliability of bonding. As has been described, the connecting projections 31, 115b, 116b are formed of the same metal material. The thermal capacities of at least the sections of the connecting projections 31, 115b, 116b including the distal end surfaces 31a, 115c, 116c are thus easily equalized by identically shaping the connecting projections 31, 115b, 116b.

(3) Bonding of the connecting projections 31, 115b, 116b is performed through welding, or by melting and joining the base materials of the connecting projections 31, 115b, 116b together. In the illustrated embodiment, the distal end surfaces 31a, 115c, 116c of the connecting projections 31, 115b, 116b are flush with one another. The distal ends of the connecting projections 31, 115b, 116b thus start to melt simultaneously, which increases the effect of welding. Particularly, since the connecting projections 31, 115b, 116b have the equal volumes and the equal thermal capacities, the connecting projections 31, 115b, 116b melt at equal speeds. The connecting projections 31, 115b, 116b are thus further reliably bonded together, further increasing the effect of welding.

(4) The connecting projections 115b, 116b of the first and second short circuit pieces 115, 116 project radially outward in the extending direction of the short circuit pieces 115, 116 (in the direction in which the short circuit pieces 115, 116 extend). The connecting projections 31 of the segments 1 to 24 are bent to project radially outward like the connecting projections 115b, 116b of the first and second short circuit pieces 115, 116. The connecting projections 115b, 116b, 31 of the first and second short circuit pieces 115, 116 and the segments 1 to 24 are axially overlapped with one another without crossing one another. This configuration makes it unnecessary to bend the connecting projections 115b, 116b with respect to the first and second short circuit pieces 115, 116. The formation of the short circuit pieces 115, 116 thus becomes easy. Further, the connecting projections 31 of the segments 1 to 24 do not cross the connecting projections 115b, 116b of the corresponding first and second short circuit pieces 115, 116. This simplifies the shapes of the connecting projections 31, facilitating formation of the connecting projections 31. Also, the connecting projections 115b, 116b, 31 of the first and second short circuit pieces 115, 116 and the segments 1 to 24 are axially overlapped with one another without crossing one another. The connecting portions of the connecting projections 115b, 116b, 31 are thus configured simply and become smaller in size.

The present invention may be embodied in the following forms.

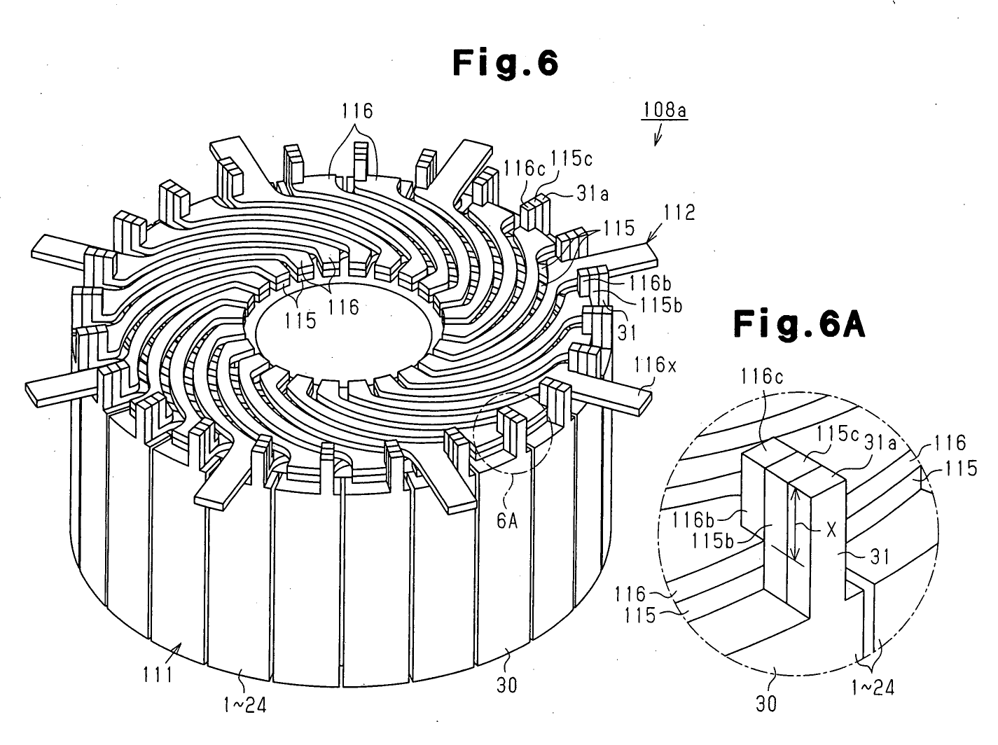

In the illustrated embodiment, the connecting projections 115b, 116b, 31 project radially outward from the first and second short circuit pieces 115, 116 or the segments 1 to 24. However, as shown in FIGS. 6 to 8, the connecting projections 115b, 116b, 31 may project axially outward from the first and second short circuit pieces 115, 116 or the segments 1 to 24.

Specifically, in a commutator 108a of FIGS. 6 and 6A, the connecting projections 31 of the segments 1 to 24 project axially outward in the extending direction of the segments 1 to 24. The connecting projections 115b, 116b of the first and second short circuit pieces 115, 116 are bent to project axially outward in the same manner as the connecting projections 31 of the segments 1 to 24. The connecting projections 115b, 116b, 31 of the first and second short circuit pieces 115, 116 and the segments 1 to 24 are radially overlapped with one another without crossing one another. At least sections of the connecting projections 115b, 116b, 31 including the distal end surfaces 115c, 116c, 31a, in this case, the projecting portions of the connecting projections 115b, 116b, 31 from the second short circuit pieces 116 (as indicated by range X of FIG. 6A), have identical shapes, equal volumes, and equal thermal capacities. The distal ends of the connecting projections 31, 115b, 116b are bonded together by pointing the machining ends of the Tig welding machine or the laser welding machine to the distal end surfaces 31a, 115c, 116c of the connecting projections 31, 115b, 116b from, for example, radially outward. Also in this case, advantages equivalent to the advantages (1) to (3) of the illustrated embodiment are ensured.

This structure also makes it unnecessary to bend the connecting projections 31 with respect to the segments 1 to 24, thus facilitating the formation of the segments 1 to 24. Further, the connecting projections 115b, 116b of the first and second short circuit pieces 115, 116 do not cross the connecting projections 31 of the segments 1 to 24. This simplifies the shapes of the connecting projections 115b, 116b, facilitating the formation of the connecting projections 115b, 116b. Also, since the connecting projections 115b, 116b, 31 of the first and second short circuit pieces 115, 116 and the segments 1 to 24 are radially overlapped with one another without crossing one another, the connecting portions of the connecting projections 115b, 116b, 31 are shaped simply and sized smaller.

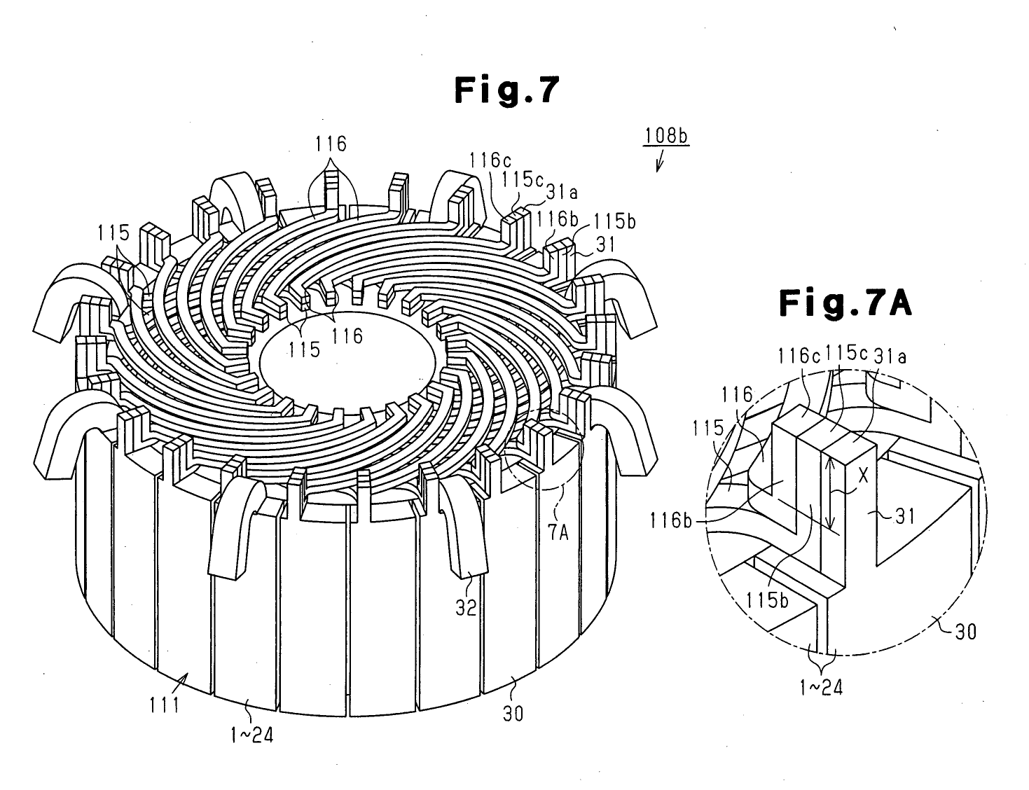

In a commutator 108b of FIGS. 7 and 7A, like the commutator 108a of FIGS. 6 and 6A, the connecting projections 115b, 116b, 31 of the first and second short circuit pieces 115, 116 and the segments 1 to 24 axially project and radially overlap one another. This configuration ensures advantages equivalent to the advantages of the commutator 108a of FIGS. 6 and 6A. In the commutator 108b, the first and short circuit pieces 115, 116 are curved in directions opposite to the curving directions of the first and short circuit pieces 115, 116 of the commutator 108a. The width of each of the first and second short circuit pieces 115, 116 is slightly smaller that that of the commutator 108a. The commutator 108b includes risers 32 to which the ends of the coils M1 to M8 are connected and fixed.

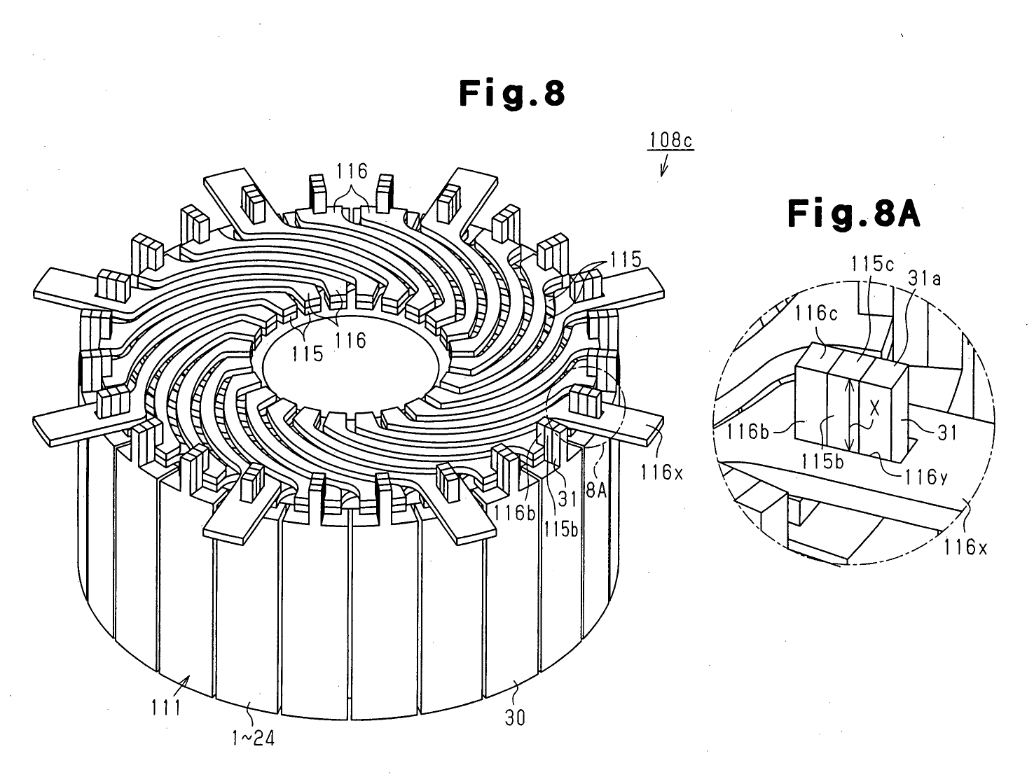

In a commutator 108c of FIGS. 8 and 8A, like the commutator 108a of FIGS. 6 and 6A, the connecting projections 115b, 116b, 31 of the first and second short circuit pieces 115, 116 and the segments 1 to 24 axially project and radially overlap one another. This configuration ensures advantages equivalent to the advantages of the commutator 108a of FIGS. 6 and 6A. In the commutator 108c, the connecting projections 31, 115b, 116b are each arranged at the circumferential middle of the corresponding one of the segments 1 to 24. The commutator 108c includes risers 116x in each of which a through hole 116y is defined. Each of the connecting projections 116b is cut and bent from the second circuit piece 116 and provided at a radial inner portion of the through hole 116y of the corresponding one of the risers 116x. The associated connecting projections 31, 115b are passed through and project from the through hole 116y.

Although the connecting projections 31, 115b, 116b are overlapped with one another axially or radially in the illustrated embodiment and modifications, the connecting projections 31, 115b, 116b do not necessarily have to be overlapped with one another in one direction. The connecting projections 31, 115b, 116b may simply be held in mutual contact and arranged adjacently.

In the illustrated embodiment and modifications, the segments 1 to 24 and the first and second short circuit pieces 115, 116 are formed of the same metal material (the same metal plate material). However, the segments 1 to 24 and the first and second short circuit pieces 115, 116 may be formed of different metal materials.

In the illustrated embodiment and modifications, the segments 1 to 24 and the first and second short circuit pieces 115, 116 are formed of the same metal material. The connecting projections 31, 115b, 116b have the identical shapes, the equal volumes, and the equal thermal capacities. However, the connecting projections 31, 115b, 116b may be shaped differently while the volumes of the connecting projections 31, 115b, 116b are equal. Further, in this case, the segments 1 to 24 and the first and second short circuit pieces 115, 116 may be formed of different materials and have different thermal capacities. As long as the volumes of the segments 1 to 24 and the first and second short circuit pieces 115, 116 are equal, the heat energies received by the connecting projections 31, 115b, 116b from the welding machine become equal. The connecting projections 31, 115b, 116b are thus bonded together effectively.

Further, the connecting projections 31, 115b, 116b may be shaped differently while the thermal capacities of the connecting projections 31, 115b, 116b are equal. In this case, the segments 1 to 24 and the first and second short circuit pieces 115, 116 may be formed of different metal materials while the volumes of the segments 1 to 24 and the first and second short circuit pieces 115, 116 are different. As long as the thermal capacities of the segments 1 to 24 and the first and second short circuit pieces 115, 116 are equal, the heat energies received by the connecting projections 31, 115b, 116b from the welding machine become equal. The connecting projections 31, 115b, 116b are thus bonded together effectively.

In the illustrated embodiment, the connecting projections 31, 115b, 116b of the segments 1 to 42 and the first and second short circuit pieces 115, 116 are bonded together through Tig welding or laser welding. However, the connecting projections 31, 115b, 116b may be welded in a different manner, for example, by a welding member such as a solder or electron beam welding.

The present examples and embodiments are to be considered as illustrative and not restrictive and the invention is not to be limited to the details given herein, but may be modified within the scope and equivalence of the appended claims.

1. A method of manufacturing a commutator, the commutator including a commutator body having a plurality of segments arranged along a circumferential direction, and a short circuit member for short-circuiting the segments, wherein the short circuit member is substantially shaped like a disk and has first short circuit pieces and second short circuit pieces that are stacked together to form a two-layer structure, the number of the first short circuit pieces and the number of the second short circuit pieces are each equal to the number of the segments, and wherein a radially inner end portion of each first short circuit piece is overlapped with and connected to a radially inner end portion of one of the second short circuit pieces, and a radially outer end portion of each first short circuit piece is overlapped with and connected to a radially outer end portion of one of the second short circuit pieces, such that a plurality of pairs of overlapped end portions arranged at a predetermined angular interval are electrically connected to one another, the method comprising:
arranging the short circuit member at an axial end of the commutator body such that each pair of the overlapped radially outer end portions corresponds to one of the segments, wherein the radially outer end portions and the segments each have a connecting projection;
arranging the connecting projections of each pair of the overlapped radially outer end portions and the connecting projection of the corresponding segment to form an adjacently arranged set of the connecting projections when the short circuit member is arranged at the axial end of the commutator body; and
welding the distal ends of each adjacently arranged set of the connecting projections, thereby bonding the distal ends together.

2. The method according to claim 1, wherein, when the short circuit member is arranged at the axial end of the commutator body, distal end surfaces of each adjacently arranged set of the connecting projections become flush, and
wherein said welding the distal ends includes welding the flush distal end surfaces.

3. The method according to claim 1, further comprising forming the connecting projections such that the connecting projections in each adjacently arranged set have equal volumes at least in a section including the distal ends.

4. The method according to claim 1, further comprising the connecting projections such that the connecting projections in each adjacently arranged set have equal thermal capacities at least in a section including the distal ends.

5. The method according to claim 1, further comprising:
forming the first and second short circuit pieces and the segments using a same metal material; and
forming the connecting projections such that the connecting projections in each adjacently arranged set have equal volumes and equal thermal capacities at least in a section including the distal ends.

6. The method according to claim 1, wherein said welding includes melting and joining base materials of the connecting projections in each adjacently arranged set.

7. The method according to claim 1, wherein each connecting projection projects outward in a radial direction of the commutator, and wherein said arranging the connecting projections to form adjacently arranged sets includes stacking the connecting projections in an axial direction of the commutator such that the connecting projections do not cross one another.

8. The method according to claim 1, wherein each connecting projection projects along an axial direction of the commutator, and wherein said arranging the connecting projections to form adjacently arranged sets includes stacking the connecting projections in a radial direction of the commutator such that the connecting projections do not cross one another.

9. A commutator, comprising:
a commutator body having a plurality of segments arranged along a circumferential direction, and
a short circuit member for short-circuiting the segments, wherein the short circuit member is substantially shaped like a disk and has first short circuit pieces and second short circuit pieces that are stacked together to form a two-layer structure, the number of the first short circuit pieces and the number of the second short circuit pieces are each equal to the number of the segments, and wherein a radially inner end portion of each first short circuit piece is overlapped with and connected to a radially inner end portion of one of the second short circuit pieces, and a radially outer end portion of each first short circuit piece is overlapped with and connected to a radially outer end portion of one of the second short circuit pieces, such that a plurality of pairs of overlapped end portions arranged at a predetermined angular interval are electrically connected to one another,
wherein the short circuit member is arranged at an axial end of the commutator body such that each pair of the overlapped radially outer end portions corresponds to one of the segments, and
wherein the radially outer end portions and the segments each have a connecting projection, wherein the connecting projections of each pair of the overlapped radially outer end portions and the connecting projection of the corresponding segment are arranged to form an adjacently arranged set of the connecting projections in a state where the short circuit member is arranged at the axial end of the commutator body, and wherein the distal ends of each adjacently arranged set of the connecting projections are bonded by welding.

10. The commutator according to claim 9, wherein, in a state where the short circuit member is arranged at the axial end of the commutator body, distal end surfaces of each adjacently arranged set of the connecting projections become flush.

11. The commutator according to claim 9, wherein the connecting projections are formed such that the connecting projections in each adjacently arranged set have equal volumes at least in a section including the distal ends.

12. The commutator according to claim 9, wherein the connecting projections are formed such that the connecting projections in each adjacently arranged set have equal thermal capacities at least in a section including the distal ends.

13. The commutator according to claim 9, wherein the first and second short circuit pieces and the segments are formed of a same metal material, and wherein the connecting projections are formed such that the connecting projections in each adjacently arranged set have equal volumes and equal thermal capacities at least in a section including the distal ends.

14. The commutator according to claim 9, wherein each connecting projection projects outward in a radial direction of the commutator, and wherein the connecting projections in each adjacently arranged set are stacked in an axial direction of the commutator such that the connecting projections do not cross one another.

15. The commutator according to claim 8, wherein each connecting projection projects along an axial direction of the commutator, and wherein the connecting projections in each adjacently arranged set are stacked in a radial direction of the commutator such that the connecting projections do not cross one another.
